(19) United States
(12) Patent Application Publication
(10) Pub. No.: US 2026/0330457 A1
(43) Pub. Date: Oct. 22, 2026

(54) SYSTEMS AND METHODS FOR DATA TRANSMISSIONS USING NEAR FIELD COMMUNICATION AND SECURE IMAGE GENERATION IN OFFLINE ENVIRONMENTS

(71) Applicant: BANK OF AMERICA CORPORATION, Charlotte, NC (US)

(72) Inventors: Radha Janakiraman, Chennai (IN); Agamya Mishra, Gurugram (IN); Bhoomika Khatri, Delhi (IN); Nandini Viswanathan, Erode (IN); Parvathypriyanga S, Tamil Nadu (IN); D Sneha, Cuddalore (IN); Saurabh Arora, Gurugram (IN)

(73) Assignee: BANK OF AMERICA CORPORATION, Charlotte, NC (US)

(21) Appl. No.: 19/184,523

(22) Filed: Apr. 21, 2025

(51) Int. Cl. G06Q 20/40

(52) U.S. Cl. CPC G06Q 20/401

(57) ABSTRACT

Systems, computer program products, and methods are described herein for data transmissions using near field communication and secure image generation in offline environments. The present disclosure is configured to determine a network fluctuation for a user device; identify at least one data transmission request from the user device; generate, based on determining the network fluctuation, an image based on the at least one data transmission request and at least one input parameter from the user device, wherein the image is generated with a least significant bit (LSB) algorithm; enhance, using a state space model, the image; and trigger a download of the enhanced image to a cache of the user device.

### TECHNOLOGICAL FIELD

Example embodiments of the present disclosure relate to systems and methods for data transmissions using near field communication and secure image generation in offline environments.

### BACKGROUND

In today's electronic environment, ensuring that data transmissions can occur even in low, or no network environments is becoming more and more important. The presence of these no, or low network environments cause challenges for users with their user devices when they cannot rely on continuous network availability. Further, this problem is exacerbated when users in these environments want to complete these data transmissions, while ensuring the data is not misappropriated by man-in-the-middle attacks, interruptions, and other such cyber-attacks. Thus, there exists a great need for a system, computer program product, or computer implemented method that can securely and efficiently transmit data using near field communication and secure image generation in no or low network environments.

Applicant has identified a number of deficiencies and problems associated with completing data transmissions in low or no network environments. Through applied effort, ingenuity, and innovation, many of these identified problems have been solved by developing solutions that are included in embodiments of the present disclosure, many examples of which are described in detail herein.

### BRIEF SUMMARY

Systems, methods, and computer program products are provided for data transmissions using near field communication and secure image generation in offline environments.

In one aspect, a system for data transmissions using near field communication and secure image generation in offline environments is provided. In some embodiments, the system may comprise: a memory device with computer-readable program code stored thereon; at least one processing device operatively coupled to the memory device and at least one communication device, wherein executing the computer-readable code is configured to cause the at least one processing device to: determine a network fluctuation for a user device; identify at least one data transmission request from the user device; generate, based on determining the network fluctuation, an image based on the at least one data transmission request and at least one input parameter from the user device, wherein the image is generated with a least significant bit (LSB) algorithm; enhance, using a state space model, the image; and trigger a download of the enhanced image to a cache of the user device.

In some embodiments, executing the computer-readable code is configured to cause the at least one processing device to: trigger a transmission of the enhanced image from the cache to a near field device. In some embodiments, executing the computer-readable code is configured to cause the at least one processing device to: trigger, at the near field device, a decode of the enhanced image, wherein the decoding comprises: applying a state space model to the enhanced image; and extract, using the state space model, the at least one data transmission request and the at least one input parameter. In some embodiments, executing the computer-readable code is configured to cause the at least one processing device to: trigger, at the near field device, a data transmission to a server associated with the data transmission request, wherein the data transmission comprises the data transmission request; and receive, at the near field device, a data transmission confirmation, wherein the data transmission confirmation comprises an approval of the data transmission request. In some embodiments, executing the computer-readable code is configured to cause the at least one processing device to: receive, from the near field device, a data transmission confirmation based on the at least one data transmission request in the enhanced image; and store the data transmission confirmation in the cache of the user device.

In some embodiments, the network fluctuation is based on a continuous monitoring of a network associated with the user device.

In some embodiments, the at least one input parameter comprises at least one user account parameter, at least one user device parameter, at least one localized parameter, or at least one time limit parameter. In some embodiments, the generation of the image comprises: encoding the at least one input parameter; and generating the image by encrypting and embedding the at least one encoded input parameter using the LSB algorithm.

In some embodiments, the state space model comprises applying scrambling to the image; and enhancing the image by blurring the image.

Similarly, and as a person of skill in the art will understand, each of the features, functions, and advantages provided herein with respect to the system disclosed hereinabove may additionally be provided with respect to a computer-implemented method and computer program product. Such embodiments are provided for exemplary purposes below and are not intended to be limited.

The above summary is provided merely for purposes of summarizing some example embodiments to provide a basic understanding of some aspects of the present disclosure. Accordingly, it will be appreciated that the above-described embodiments are merely examples and should not be construed to narrow the scope or spirit of the disclosure in any way. It will be appreciated that the scope of the present disclosure encompasses many potential embodiments in addition to those here summarized, some of which will be further described below.

### BRIEF DESCRIPTION OF THE DRAWINGS

Having thus described embodiments of the disclosure in general terms, reference will now be made the accompanying drawings. The components illustrated in the figures may or may not be present in certain embodiments described herein. Some embodiments may include fewer (or more) components than those shown in the figures.

FIGS. 1A-1C illustrates technical components of an exemplary distributed computing environment for data transmissions using near field communication and secure image generation in offline environments, in accordance with an embodiment of the disclosure;

FIG. 2 illustrates a process flow for data transmissions using near field communication and secure image generation in offline environments, in accordance with an embodiment of the disclosure;

FIG. 3 illustrates a process flow for completing the data transmission request in low or no network environments, in accordance with an embodiment of the disclosure;

FIG. 4 illustrates a process flow for generating the image, in accordance with an embodiment of the disclosure;

FIG. 5 illustrates a flow diagram for enhancing the image, in accordance with an embodiment of the disclosure;

FIG. 6 illustrates an architecture flow for data transmissions using near field communication and secure image generation in offline environments, in accordance with an embodiment of the disclosure;

FIG. 7 illustrates an exemplary flow for image generation, in accordance with an embodiment of the disclosure;

FIG. 8 illustrates an exemplary flow for encoding and decoding the image, in accordance with an embodiment of the disclosure; and

FIG. 9 illustrates an exemplary flow for completing a data transmission request for a user in a low or no network environment, in accordance with an embodiment of the disclosure.

### DETAILED DESCRIPTION

Embodiments of the present disclosure will now be described more fully hereinafter with reference to the accompanying drawings, in which some, but not all, embodiments of the disclosure are shown. Indeed, the disclosure may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

As used herein, an “entity” may be any institution employing information technology resources and particularly technology infrastructure configured for processing large amounts of data. Typically, these data can be related to the people who work for the organization, its products or services, the customers or any other aspect of the operations of the organization. As such, the entity may be any institution, group, association, financial institution, establishment, company, union, authority or the like, employing information technology resources for processing large amounts of data.

As described herein, a “user” may be an individual associated with an entity. As such, in some embodiments, the user may be an individual having past relationships, current relationships or potential future relationships with an entity. In some embodiments, the user may be an employee (e.g., an associate, a project manager, an IT specialist, a manager, an administrator, an internal operations analyst, or the like) of the entity or enterprises affiliated with the entity.

As used herein, a “user interface” may be a point of human-computer interaction and communication in a device that allows a user to input information, such as commands or data, into a device, or that allows the device to output information to the user. For example, the user interface includes a graphical user interface (GUI) or an interface to input computer-executable instructions that direct a processor to carry out specific functions. The user interface typically employs certain input and output devices such as a display, mouse, keyboard, button, touchpad, touch screen, microphone, speaker, LED, light, joystick, switch, buzzer, bell, and/or other user input/output device for communicating with one or more users.

As used herein, “authentication credentials” may be any information that can be used to identify of a user. For example, a system may prompt a user to enter authentication information such as a username, a password, a personal identification number (PIN), a passcode, biometric information (e.g., iris recognition, retina scans, fingerprints, finger veins, palm veins, palm prints, digital bone anatomy/structure and positioning (distal phalanges, intermediate phalanges, proximal phalanges, and the like), an answer to a security question, a unique intrinsic user activity, such as making a predefined motion with a user device. This authentication information may be used to authenticate the identity of the user (e.g., determine that the authentication information is associated with the account) and determine that the user has authority to access an account or system. In some embodiments, the system may be owned or operated by an entity. In such embodiments, the entity may employ additional computer systems, such as authentication servers, to validate and certify resources inputted by the plurality of users within the system. The system may further use its authentication servers to certify the identity of users of the system, such that other users may verify the identity of the certified users. In some embodiments, the entity may certify the identity of the users. Furthermore, authentication information or permission may be assigned to or required from a user, application, computing node, computing cluster, or the like to access stored data within at least a portion of the system.

It should also be understood that “operatively coupled,” as used herein, means that the components may be formed integrally with each other, or may be formed separately and coupled together. Furthermore, “operatively coupled” means that the components may be formed directly to each other, or to each other with one or more components located between the components that are operatively coupled together. Furthermore, “operatively coupled” may mean that the components are detachable from each other, or that they are permanently coupled together. Furthermore, operatively coupled components may mean that the components retain at least some freedom of movement in one or more directions or may be rotated about an axis (i.e., rotationally coupled, pivotally coupled). Furthermore, “operatively coupled” may mean that components may be electronically connected and/or in fluid communication with one another.

As used herein, an “interaction” may refer to any communication between one or more users, one or more entities or institutions, one or more devices, nodes, clusters, or systems within the distributed computing environment described herein. For example, an interaction may refer to a transfer of data between devices, an accessing of stored data by one or more nodes of a computing cluster, a transmission of a requested task, or the like.

It should be understood that the word “exemplary” is used herein to mean “serving as an example, instance, or illustration.” Any implementation described herein as “exemplary” is not necessarily to be construed as advantageous over other implementations.

As used herein, “determining” may encompass a variety of actions. For example, “determining” may include calculating, computing, processing, deriving, investigating, ascertaining, and/or the like. Furthermore, “determining” may also include receiving (e.g., receiving information), accessing (e.g., accessing data in a memory), and/or the like. Also, “determining” may include resolving, selecting, choosing, calculating, establishing, and/or the like. Determining may also include ascertaining that a parameter matches a predetermined criterion, including that a threshold has been met, passed, exceeded, and so on.

As used herein, a “resource” may generally refer to objects, products, devices, goods, commodities, services, and the like, and/or the ability and opportunity to access and use the same. Some example implementations herein contemplate property held by a user, including property that is stored and/or maintained by a third-party entity. In some example implementations, a resource may be associated with one or more accounts or may be property that is not associated with a specific account. Examples of resources associated with accounts may be accounts that have cash or cash equivalents, commodities, and/or accounts that are funded with or contain property, such as safety deposit boxes containing jewelry, art or other valuables, a trust account that is funded with property, or the like. For purposes of this disclosure, a resource is typically stored in a resource repository-a storage location where one or more resources are organized, stored and retrieved electronically using a computing device.

As used herein, a “resource transfer,” “resource transmission,” “resource distribution,” or “resource allocation” may refer to any transaction, activities or communication between one or more entities, or between the user and the one or more entities. A resource transfer may refer to any distribution of resources such as, but not limited to, a payment, processing of funds, purchase of goods or services, a return of goods or services, a payment transaction, a credit transaction, or other interactions involving a user's resource or account. Unless specifically limited by the context, a “resource transfer” a “transaction”, “transaction event” or “point of transaction event” may refer to any activity between a user, a merchant, an entity, or any combination thereof. In some embodiments, a resource transfer or transaction may refer to financial transactions involving direct or indirect movement of funds through traditional paper transaction processing systems (i.e. paper check processing) or through electronic transaction processing systems. Typical financial transactions include point of sale (POS) transactions, automated teller machine (ATM) transactions, person-to-person (P2P) transfers, internet transactions, online shopping, electronic funds transfers between accounts, transactions with a financial institution teller, personal checks, conducting purchases using loyalty/rewards points etc. When discussing that resource transfers or transactions are evaluated, it could mean that the transaction has already occurred, is in the process of occurring or being processed, or that the transaction has yet to be processed/posted by one or more financial institutions. In some embodiments, a resource transfer or transaction may refer to non-financial activities of the user. In this regard, the transaction may be a customer account event, such as but not limited to the customer changing a password, ordering new checks, adding new accounts, opening new accounts, adding or modifying account parameters/restrictions, modifying a payee list associated with one or more accounts, setting up automatic payments, performing/modifying authentication procedures and/or credentials, and the like.

In today's electronic environment, ensuring that data transmissions can occur even in low, or no network environments is becoming more and more important. The presence of these no, or low network environments cause challenges for users with their user devices when they cannot rely on continuous network availability. Further, this problem is exacerbated when users in these environments want to complete these data transmissions, while ensuring the data is not misappropriated by man-in-the-middle attacks, interruptions, and other such cyber-attacks. Thus, there exists a great need for a system, computer program product, or computer implemented method that can securely and efficiently transmit data using near field communication and secure image generation in no or low network environments.

Accordingly, the present disclosure provides for the determination of a network fluctuation for a user device; identification of at least one data transmission request from the user device; generation, based on determining the network fluctuation, of an image based on the at least one data transmission request and at least one input parameter from the user device, wherein the image is generated with a least significant bit (LSB) algorithm; enhancement, using a state space model, of the image; and a triggering of a download of the enhanced image to a cache of the user device. Additionally, and in some embodiments, the disclosure further provides for a triggering of a transmission of the enhanced image from the cache to a near field device; a triggering, at the near field device, of a decode of the enhanced image, wherein the decoding comprises: an application of a state space model to the enhanced image; and an extraction, using the state space model, of the at least one data transmission request and the at least one input parameter. In some additional embodiments, the disclosure provides for the triggering, at the near field device, of a data transmission to a server associated with the data transmission request, wherein the data transmission comprises the data transmission request; and a receipt, at the near field device, of a data transmission confirmation, wherein the data transmission confirmation comprises an approval of the data transmission request. In some embodiments, the disclosure may provide for the receipt, from the near field device, of the data transmission confirmation based on the at least one data transmission request in the enhanced image; and a storage of the data transmission confirmation in the cache of the user device.

In other words, the disclosure provides a system for transmitting data securely and in low or offline environments. For instance, the system may generate an image using localized data for the transmissions at a user's end-device, creating a one-time image using state space models to enhance/encrypt the image before transmission of the image using near field communication (NFC) to near network-connected devices (e.g., point of sale devices, and/or the like). At the near network-connected device, the image may be decrypted using similar state space model methods to determine the information within the data transmission for the data transmission to be completed and transmitted to an appropriate device for further analysis.

What is more, the present disclosure provides a technical solution to a technical problem. As described herein, the technical problem includes the completion of data transmissions in low or no network environments. The technical solution presented herein allows for the completion of data transmissions using near field communication and state space models for secure image generation. In particular, the disclosure provided herein is an improvement over existing solutions to the transmission of data in low or no network environments, (i) with fewer steps to achieve the solution, thus reducing the amount of computing resources, such as processing resources, storage resources, network resources, and/or the like, that are being used, (ii) providing a more accurate solution to problem, thus reducing the number of resources required to remedy any errors made due to a less accurate solution, (iii) removing manual input and waste from the implementation of the solution, thus improving speed and efficiency of the process and conserving computing resources, (iv) determining an optimal amount of resources that need to be used to implement the solution, thus reducing network traffic and load on existing computing resources. Furthermore, the technical solution described herein uses a rigorous, computerized process to perform specific tasks and/or activities that were not previously performed. In specific implementations, the technical solution bypasses a series of steps previously implemented, thus further conserving computing resources.

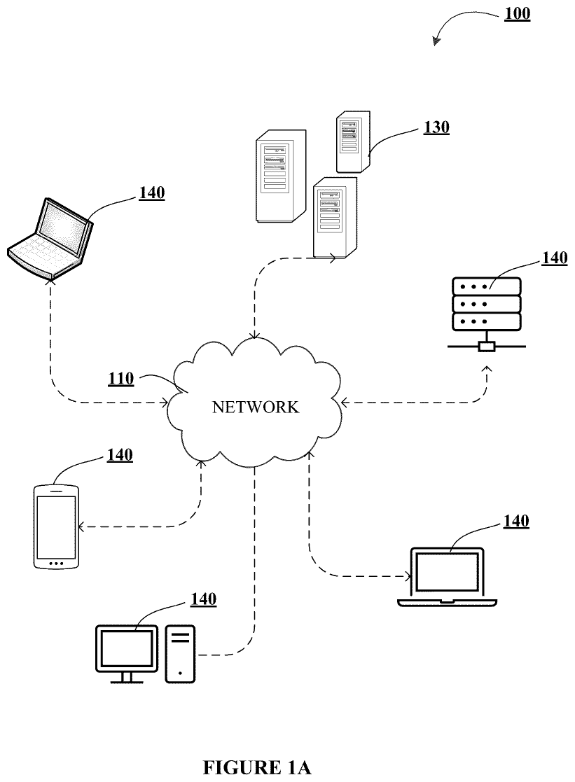

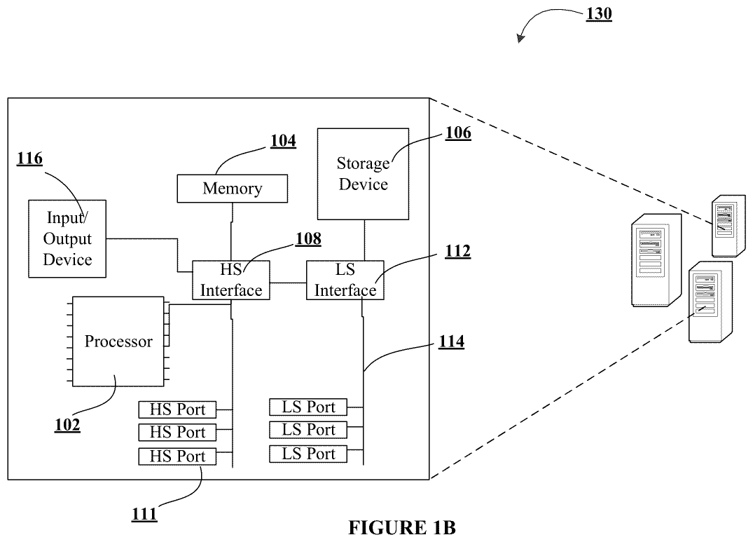

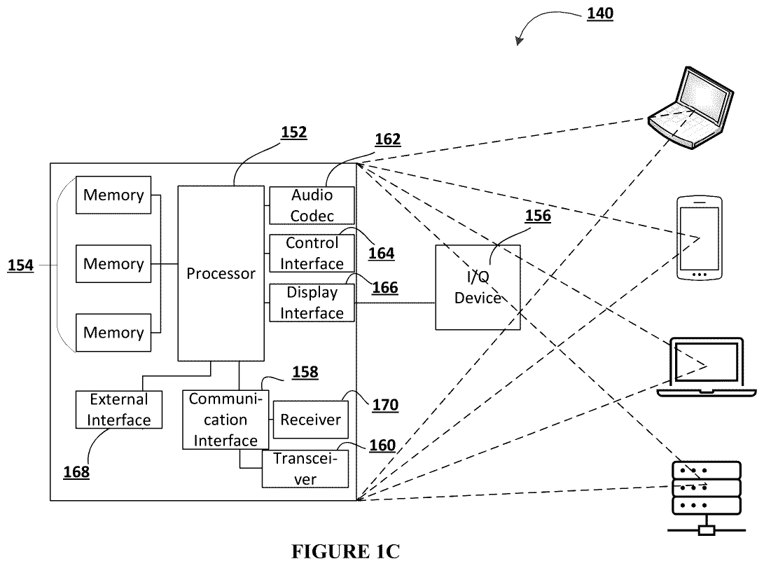

FIGS. 1A-1C illustrate technical components of an exemplary distributed computing environment for data transmissions using near field communication and secure image generation in offline environments 100, in accordance with an embodiment of the disclosure. As shown in FIG. 1A, the distributed computing environment 100 contemplated herein may include a system 130, an end-point device(s) 140, and a network 110 over which the system 130 and end-point device(s) 140 communicate therebetween. FIG. 1A illustrates only one example of an embodiment of the distributed computing environment 100, and it will be appreciated that in other embodiments one or more of the systems, devices, and/or servers may be combined into a single system, device, or server, or be made up of multiple systems, devices, or servers. Also, the distributed computing environment 100 may include multiple systems, same or similar to system 130, with each system providing portions of the necessary operations (e.g., as a server bank, a group of blade servers, or a multi-processor system).

In some embodiments, the system 130 and the end-point device(s) 140 may have a client-server relationship in which the end-point device(s) 140 are remote devices that request and receive service from a centralized server, i.e., the system 130. In some other embodiments, the system 130 and the end-point device(s) 140 may have a peer-to-peer relationship in which the system 130 and the end-point device(s) 140 are considered equal and all have the same abilities to use the resources available on the network 110. Instead of having a central server (e.g., system 130) which would act as the shared drive, each device that is connect to the network 110 would act as the server for the files stored on it.

The system 130 may represent various forms of servers, such as web servers, database servers, file server, or the like, various forms of digital computing devices, such as laptops, desktops, video recorders, audio/video players, radios, workstations, or the like, or any other auxiliary network devices, such as wearable devices, Internet-of-things devices, electronic kiosk devices, entertainment consoles, mainframes, or the like, or any combination of the aforementioned.

The end-point device(s) 140 may represent various forms of electronic devices, including user input devices such as personal digital assistants, cellular telephones, smartphones, laptops, desktops, and/or the like, merchant input devices such as point-of-sale (POS) devices, electronic payment kiosks, and/or the like, electronic telecommunications device (e.g., automated teller machine (ATM)), and/or edge devices such as routers, routing switches, integrated access devices (IAD), and/or the like.

The network 110 may be a distributed network that is spread over different networks. This provides a single data communication network, which can be managed jointly or separately by each network. Besides shared communication within the network, the distributed network often also supports distributed processing. The network 110 may be a form of digital communication network such as a telecommunication network, a local area network (“LAN”), a wide area network (“WAN”), a global area network (“GAN”), the Internet, or any combination of the foregoing. The network 110 may be secure and/or unsecure and may also include wireless and/or wired and/or optical interconnection technology.

It is to be understood that the structure of the distributed computing environment and its components, connections and relationships, and their functions, are meant to be exemplary only, and are not meant to limit implementations of the disclosures described and/or claimed in this document. In one example, the distributed computing environment 100 may include more, fewer, or different components. In another example, some or all of the portions of the distributed computing environment 100 may be combined into a single portion or all of the portions of the system 130 may be separated into two or more distinct portions.

FIG. 1B illustrates an exemplary component-level structure of the system 130, in accordance with an embodiment of the disclosure. As shown in FIG. 1B, the system 130 may include a processor 102, memory 104, input/output (I/O) device 116, and a storage device 110. The system 130 may also include a high-speed interface 108 connecting to the memory 104, and a low-speed interface 112 connecting to low speed bus 114 and storage device 110. Each of the components 102, 104, 108, 110, and 112 may be operatively coupled to one another using various buses and may be mounted on a common motherboard or in other manners as appropriate. As described herein, the processor 102 may include a number of subsystems to execute the portions of processes described herein. Each subsystem may be a self-contained component of a larger system (e.g., system 130) and capable of being configured to execute specialized processes as part of the larger system.

The processor 102 can process instructions, such as instructions of an application that may perform the functions disclosed herein. These instructions may be stored in the memory 104 (e.g., non-transitory storage device) or on the storage device 110, for execution within the system 130 using any subsystems described herein. It is to be understood that the system 130 may use, as appropriate, multiple processors, along with multiple memories, and/or I/O devices, to execute the processes described herein.

The memory 104 stores information within the system 130. In one implementation, the memory 104 is a volatile memory unit or units, such as volatile random access memory (RAM) having a cache area for the temporary storage of information, such as a command, a current operating state of the distributed computing environment 100, an intended operating state of the distributed computing environment 100, instructions related to various methods and/or functionalities described herein, and/or the like. In another implementation, the memory 104 is a non-volatile memory unit or units. The memory 104 may also be another form of computer-readable medium, such as a magnetic or optical disk, which may be embedded and/or may be removable. The non-volatile memory may additionally or alternatively include an EEPROM, flash memory, and/or the like for storage of information such as instructions and/or data that may be read during execution of computer instructions. The memory 104 may store, recall, receive, transmit, and/or access various files and/or information used by the system 130 during operation.

The storage device 106 is capable of providing mass storage for the system 130. In one aspect, the storage device 106 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier may be a non-transitory computer-or machine-readable storage medium, such as the memory 104, the storage device 104, or memory on processor 102.

The high-speed interface 108 manages bandwidth-intensive operations for the system 130, while the low speed controller 112 manages lower bandwidth-intensive operations. Such allocation of functions is exemplary only. In some embodiments, the high-speed interface 108 is coupled to memory 104, input/output (I/O) device 116 (e.g., through a graphics processor or accelerator), and to high-speed expansion ports 111, which may accept various expansion cards (not shown). In such an implementation, low-speed controller 112 is coupled to storage device 106 and low-speed expansion port 114. The low-speed expansion port 114, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The system 130 may be implemented in a number of different forms. For example, the system 130 may be implemented as a standard server, or multiple times in a group of such servers. Additionally, the system 130 may also be implemented as part of a rack server system or a personal computer such as a laptop computer. Alternatively, components from system 130 may be combined with one or more other same or similar systems and an entire system 130 may be made up of multiple computing devices communicating with each other.

FIG. 1C illustrates an exemplary component-level structure of the end-point device(s) 140, in accordance with an embodiment of the disclosure. As shown in FIG. 1C, the end-point device(s) 140 includes a processor 152, memory 154, an input/output device such as a display 156, a communication interface 158, and a transceiver 160, among other components. The end-point device(s) 140 may also be provided with a storage device, such as a microdrive or other device, to provide additional storage. Each of the components 152, 154, 158, and 160, are interconnected using various buses, and several of the components may be mounted on a common motherboard or in other manners as appropriate.

The processor 152 is configured to execute instructions within the end-point device(s) 140, including instructions stored in the memory 154, which in one embodiment includes the instructions of an application that may perform the functions disclosed herein, including certain logic, data processing, and data storing functions. The processor may be implemented as a chipset of chips that include separate and multiple analog and digital processors. The processor may be configured to provide, for example, for coordination of the other components of the end-point device(s) 140, such as control of user interfaces, applications run by end-point device(s) 140, and wireless communication by end-point device(s) 140.

The processor 152 may be configured to communicate with the user through control interface 164 and display interface 166 coupled to a display 156. The display 156 may be, for example, a TFT LCD (Thin-Film-Transistor Liquid Crystal Display) or an OLED (Organic Light Emitting Diode) display, or other appropriate display technology. The display interface 156 may comprise appropriate circuitry and configured for driving the display 156 to present graphical and other information to a user. The control interface 164 may receive commands from a user and convert them for submission to the processor 152. In addition, an external interface 168 may be provided in communication with processor 152, so as to enable near area communication of end-point device(s) 140 with other devices. External interface 168 may provide, for example, for wired communication in some implementations, or for wireless communication in other implementations, and multiple interfaces may also be used.

The memory 154 stores information within the end-point device(s) 140. The memory 154 can be implemented as one or more of a computer-readable medium or media, a volatile memory unit or units, or a non-volatile memory unit or units. Expansion memory may also be provided and connected to end-point device(s) 140 through an expansion interface (not shown), which may include, for example, a SIMM (Single In Line Memory Module) card interface. Such expansion memory may provide extra storage space for end-point device(s) 140 or may also store applications or other information therein. In some embodiments, expansion memory may include instructions to carry out or supplement the processes described above and may include secure information also. For example, expansion memory may be provided as a security module for end-point device(s) 140 and may be programmed with instructions that permit secure use of end-point device(s) 140. In addition, secure applications may be provided via the SIMM cards, along with additional information, such as placing identifying information on the SIMM card in a non-hackable manner.

The memory 154 may include, for example, flash memory and/or NVRAM memory. In one aspect, a computer program product is tangibly embodied in an information carrier. The computer program product contains instructions that, when executed, perform one or more methods, such as those described herein. The information carrier is a computer-or machine-readable medium, such as the memory 154, expansion memory, memory on processor 152, or a propagated signal that may be received, for example, over transceiver 160 or external interface 168.

In some embodiments, the user may use the end-point device(s) 140 to transmit and/or receive information or commands to and from the system 130 via the network 110. Any communication between the system 130 and the end-point device(s) 140 may be subject to an authentication protocol allowing the system 130 to maintain security by permitting only authenticated users (or processes) to access the protected resources of the system 130, which may include servers, databases, applications, and/or any of the components described herein. To this end, the system 130 may trigger an authentication subsystem that may require the user (or process) to provide authentication credentials to determine whether the user (or process) is eligible to access the protected resources. Once the authentication credentials are validated and the user (or process) is authenticated, the authentication subsystem may provide the user (or process) with permissioned access to the protected resources. Similarly, the end-point device(s) 140 may provide the system 130 (or other client devices) permissioned access to the protected resources of the end-point device(s) 140, which may include a GPS device, an image capturing component (e.g., camera), a microphone, and/or a speaker.

The end-point device(s) 140 may communicate with the system 130 through communication interface 158, which may include digital signal processing circuitry where necessary. Communication interface 158 may provide for communications under various modes or protocols, such as the Internet Protocol (IP) suite (commonly known as TCP/IP). Protocols in the IP suite define end-to-end data handling methods for everything from packetizing, addressing and routing, to receiving. Broken down into layers, the IP suite includes the link layer, containing communication methods for data that remains within a single network segment (link); the Internet layer, providing internetworking between independent networks; the transport layer, handling host-to-host communication; and the application layer, providing process-to-process data exchange for applications. Each layer contains a stack of protocols used for communications. In addition, the communication interface 158 may provide for communications under various telecommunications standards (2G, 3G, 4G, 5G, and/or the like) using their respective layered protocol stacks. These communications may occur through a transceiver 160, such as radio-frequency transceiver. In addition, short-range communication may occur, such as using a Bluetooth, Wi-Fi, or other such transceiver (not shown). In addition, GPS (Global Positioning System) receiver module 170 may provide additional navigation- and location-related wireless data to end-point device(s) 140, which may be used as appropriate by applications running thereon, and in some embodiments, one or more applications operating on the system 130.

The end-point device(s) 140 may also communicate audibly using audio codec 162, which may receive spoken information from a user and convert the spoken information to usable digital information. Audio codec 162 may likewise generate audible sound for a user, such as through a speaker, e.g., in a handset of end-point device(s) 140. Such sound may include sound from voice telephone calls, may include recorded sound (e.g., voice messages, music files, etc.) and may also include sound generated by one or more applications operating on the end-point device(s) 140, and in some embodiments, one or more applications operating on the system 130.

Various implementations of the distributed computing environment 100, including the system 130 and end-point device(s) 140, and techniques described here can be realized in digital electronic circuitry, integrated circuitry, specially designed ASICs (application specific integrated circuits), computer hardware, firmware, software, and/or combinations thereof.

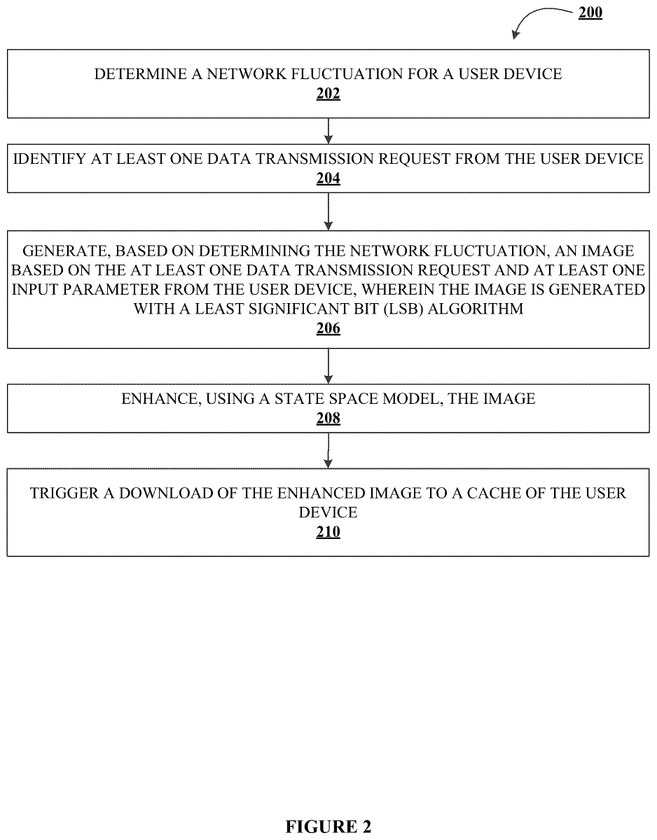

FIG. 2 illustrates a process flow 200 for data transmissions using near field communication and secure image generation in offline environments, in accordance with an embodiment of the disclosure. In some embodiments, a system (e.g., similar to one or more of the systems described herein with respect to FIGS. 1A-1C) may perform one or more of the steps of process flow 200. For example, a system (e.g., the system 130 described herein with respect to FIG. 1A-1C) may perform the steps of process 200.

As shown in block 202, the process flow 200 may include the step of determining a network fluctuation for a user device. For example, the system may use a network monitor which may be stored within the user device (e.g., mobile device, personal computer, tablet and/or the like) and/or may be operatively connected to the user device. In some embodiments, the network monitor may be downloaded to the user device by way of an application, dashboards, and/or the like. In some embodiments, the network monitor may determine fluctuations or irregular variations in internet connectivity for the user device, where the user device may experience inconsistent network/online access. In some embodiments, the network fluctuation may comprise a sudden drop to low or no network access for the user device. In such embodiments where a network fluctuation is identified, the system may trigger the start of the process described herein which allows for data transmissions even in these low or no network instances.

In some embodiments, the network fluctuation is based on a continuous monitoring of a network associated with the user device. Thus, and in other words, the system may be configured to continuously monitor the network conditions for the user device, and upon a real time or near real time determination of a network fluctuation, the system may automatically trigger/start the processes described herein. In such embodiments, and by triggering the processes descried herein in real time or near real time, the system ensures the least amount of downtime is possible for the user device to communicate with near field devices even when the user device is in a low or no network environment.

As shown in block 204, the process flow 200 may include the step of identifying at least one data transmission request form the user device. For example, the system may identify a current data transmission request that is unable to be completed due to the network fluctuation. For instance, such a data transmission request may comprise, but is not limited to, a resource transmission request from a resource account associated with the user of the user device, a transmission request to transmit secure data from the user device to at least one secondary device, a transmission request to transmit data from a secondary device to a third party device, and/or the like. In this manner, the system may determine a data transmission request that was generated at the user device, but was unable to be transmitted over the network to a recipient device.

In some embodiments, the data transmission request may comprise data such as but not limited to a timestamp of when the data transmission request was generated and/or attempted transmission, the user account identifier associated with the data transmission request generation (e.g., the sender user account, a sender resource account, and/or the like), a recipient user account (e.g., the recipient user account, recipient resource account, and/or the like), the data to be transmitted (e.g., amount of resource to be transmitted, specific data to be transmitted, and/or the like), and/or the like.

As shown in block 206, the process flow 200 may include the step of generating, based on determining the network fluctuation, an image based on the at least one data transmission request and at least one input parameter from the user device, wherein the image is generated with a least significant bit (LSB) algorithm. As used herein, the input parameters may comprise but are not limited to a preset transmission limit (e.g., a resource limit may be preset for the associated user account for these no or low network data transmissions), a user device parameter, a localized parameter, and/or a time limit parameter. For example, such a preset transmission limit may comprise a preset resource transmission limit (e.g., a $100 limit for these types of data transmissions, a $100 total transmission limit per day, a $100 overall transmission limit for the total of all transmissions using this no or low network data transmission, and/or the like). In some embodiments, the user device parameter comprises settings or configurations specific to the user device and configured on the user device (e.g., parameters specific to the user, such as preferred language, notification settings, organization of applications, data transmission settings, and/or the like). Such a localized parameter may comprise parameters specific to the user device (e.g., authorization parameters specific to the user device which are configured to allow or block interactions by a user at the user device, authentication parameters specific to the user device that identify the user as an authorized or unauthorized user, and/or the like). Such a time limit parameter may comprise a time limit for any data transmission request and/or any image generated at the user device. For example, and in some such embodiments, the time limit parameter may be used to generate the image, and thus, the image may be automatically deleted, corrupted, and/or the like at the time the time limit expires.

Thus, and by way of non-limiting example, the image may be generated using at least a user account identifier for the sender user account, a preset resource transaction limit, a time at which the image was generated, and a time limit for the image/data transmission request.

Thus, and in some embodiments, the system may generate the image of the data transmission request by creating an initial image using data from the data transmission request and at least one input parameter. In some such embodiments, the system may encode the inputs (e.g., the data of the data transmission and the input parameter(s)) using sub-bytes and random swapping of the pixels within the image. In some embodiments, the image may be pre-generated before the process described herein, the image may be generated in parallel to the process described herein, or the process described herein may generate the image.

In some embodiments, pixels of the image may be separately identified, and each color of each pixel may be determined using a red/green/blue (RGB) color model. Once the colors and their individual pixel placement have been determined, the system may extract a binary code from the RGB color model based on the placement of the pixels and the color of each pixel. In parallel to this process of determining the binary code of the image, the system may encode the inputs (e.g., input parameter(s) and data transmission data) and generate a binary code from the input. Then, and in response to generating the binary code for the inputs, the system may use a least significant bit algorithm to hide the encoded input to the least significant bits of the image's binary code to modify the image to hide the inputs. For example, and where the binary code for the image comprises 1000100, and the encoded input comprises 73 (binary code, 01110011), then the system may modify the image's binary code to include the least significant bit (e.g., the binary code for the image may now read 1000101, where 01110011 was taken from the encoded input binary code). Thus, and based on this modified image binary code, the system may replace the least significant bit of the original image's binary code of color with message data comprising the input(s). In this manner, the system may hide the secure data within the original image and the modified image will appear almost the same as the original image.

For instance, the system may comprise a state space model configured to scramble the pixels and blur the image to further secure the data within the image from unauthorized access. For example, the modified image from block 206, apply a scrambling factor to the pixels within the modified image, and then apply a blurring factor to the scrambled image. In some embodiments, the scrambling factor may be applied to the entire modified image, and the intensity of the pixels in the modified image may be changed by applying the scrambling factor. In some embodiments, the application of the scrambling factor comprises a numerical value that determines the degree that the pixels are rearranged, deleted, and/or the like.

In some embodiments, the blurring of the scrambled image may comprise a blurring factor. Such a blurring factor may be added to the image to smooth the lines and edges within the image. In some embodiments, the blurring factor and the scrambling factor may comprise the same numerical value. In additional embodiments, the blurring factor and the scrambling factor may comprise different numerical values. In some embodiments, the blurring factor and the scrambling factors may be pre-determined or generated dynamically and randomly by the system at the time the image is generated or modified. Importantly, by scrambling and blurring the modified image, the modified image may be enhanced to prevent cyberattacks, man-in-the-middle attacks, and other such unauthorized decrypting if the enhanced image were to be copied or intercepted.

As shown in block 208, the process flow 200 may include the step of enhancing, using a state space model, the image. For instance, the state space model may process the image by applying the modified image to a tuned state space model that is tuned to the local parameters of attention complexity, device details, and spatial inputs. In some embodiments, the state space model may be configured to use attention complexity of the state space model (e.g., by processing the image sequentially and/or in parallel, which decreases cost and processing power needed for the state space model), the spatial input (e.g., the modified image), and the local parameters (e.g., parameters that may be specific to the state space model, such as but not limited to individual time periods, observations, noise parameters, and/or the like), and/or the like.

In some embodiments, the attention complexity and local parameters may be used to determine the blurring factor and the scrambling factor for the image. In some such embodiments, the state space model may comprise the process for scrambling and blurring the image. For instance, the system may comprise a state space model configured to scramble the pixels and blur the image to further secure the data within the image from unauthorized access. For example, the modified image from block 206, apply a scrambling factor to the pixels within the modified image, and then apply a blurring factor to the scrambled image. In some embodiments, the scrambling factor may be applied to the entire modified image, and the intensity of the pixels in the modified image may be changed by applying the scrambling factor. In some embodiments, the application of the scrambling factor comprises a numerical value that determines the degree that the pixels are rearranged, deleted, and/or the like.

In some embodiments, the blurring of the scrambled image may comprise a blurring factor. Such a blurring factor may be added to the image to smooth the lines and edges within the image. In some embodiments, the blurring factor and the scrambling factor may comprise the same numerical value. In additional embodiments, the blurring factor and the scrambling factor may comprise different numerical values. In some embodiments, the blurring factor and the scrambling factors may be pre-determined or generated dynamically and randomly by the system at the time the image is generated or modified. Importantly, by scrambling and blurring the modified image, the modified image may be enhanced to prevent cyberattacks, man-in-the-middle attacks, and other such unauthorized decrypting if the enhanced image were to be copied or intercepted.

As shown in block 210, the process flow 200 may include the step of triggering a download of the enhanced image to a cache of the user device. For instance, the enhanced image generated by the system may be stored in the user device's cache storage. As understood by a person of skill in the art, the cache storage comprises a temporary storage location that typically stores data for easy and quick access. Importantly, and by storing it in the cache of the user device, the system ensures that the image is only viable and usable by the user device for a limited amount of time, which in turn ensures security of the image and its underlying data. In some alternative embodiments, the enhanced image may be stored in long-term storage within the user device until the data transmission request has been completed.

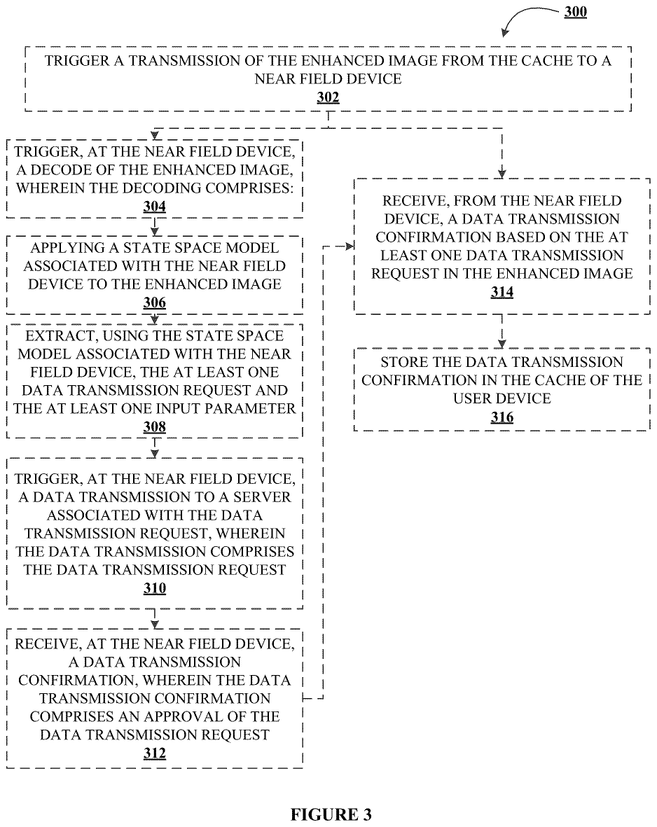

FIG. 3 illustrates a process flow 300 for completing the data transmission request in low or no network environments, in accordance with an embodiment of the disclosure. In some embodiments, a system (e.g., similar to one or more of the systems described herein with respect to FIGS. 1A-1C) may perform one or more of the steps of process flow 300. For example, a system (e.g., the system 130 described herein with respect to FIG. 1A-1C) may perform the steps of process 300.

In some embodiments, and as shown in block 302, the process flow 300 may include the step of triggering a transmission of the enhanced image from the cache to the near field device. For instance, and in some such embodiments, the system may trigger a transmission of the enhanced image from the cache storage within the user device to a near field device using near field communication. Such near field communication (NFC) comprises a short-range wireless technology which allows data to be exchanged between devices in short range from each other. In some embodiments, the NFC technology is based on radio-frequency identification (RFID) technology. In some embodiments, the near field device may comprise a point of sale device, a device owned and operated by the user of the user device, a device and owned and operated by secondary entity separate from the user of the user device, and/or the like.

In some embodiments, and as shown in block 304, the process flow 300 may include the step of triggering, at a near field device, a decode of the enhanced image, wherein the decoding comprises some or all the steps of blocks 306-312.

In some embodiments, and as shown in block 306, the process flow 300 may include the step of applying a state space model associated with the near field device to the enhanced image. For instance, the state space model herein described may be configured to debrief or decode the enhanced image. In some embodiments, the state space model used to decode/debrief the image may be stored, housed, and/or operated on a device external to the user device. In some embodiments, the state space model used to debrief the enhanced image may be stored, housed, or operated at the near field device, such as but not limited to a point of sale device, a personal computer, a tablet, and/or the like.

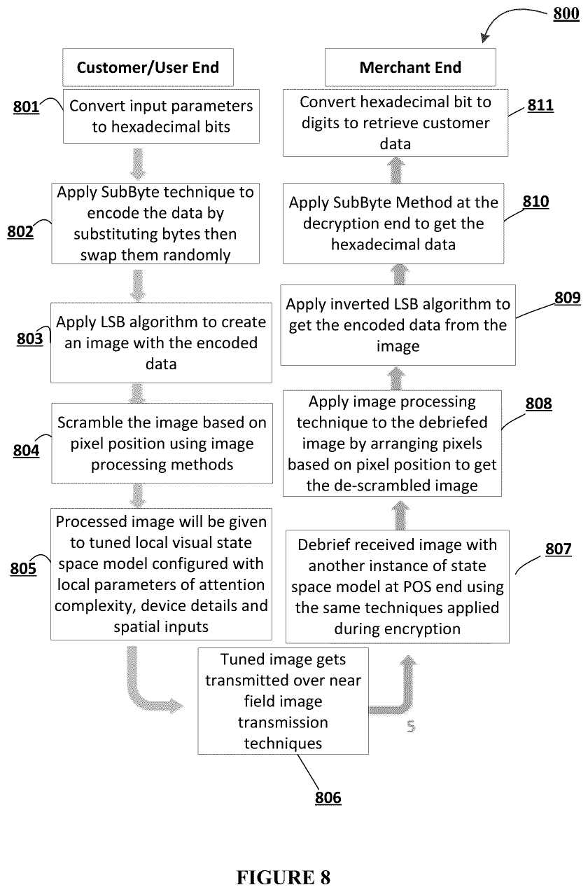

In some embodiments, and as shown in block 308, the process flow 300 may include the step of extracting, using the state space model associated with the near field device, the at least one data transmission request and the at least one input parameter. For instance, the system may extract the at least one data transmission request from the enhanced image using the state space model. For example, the state space model used to debrief may use the same steps as those used to generate the enhanced image, but in the reverse. In some such embodiments, the state space model used to debrief the enhanced image may use the blurring factor and the scrambling factor to unblur and unscramble the enhanced image in a step-by-step manner (e.g., unblur first, then unscramble). Further, and in some embodiments, the system may also apply an inverted LSB algorithm to the unscrambled and unblurred image to determine the encoded data within the image. Such an embodiment is described in further detail below with respect to FIG. 8.

In some embodiments, and as shown in block 310, the process flow 300 may include the step of triggering, at the near field device, a data transmission to a server associated with the data transmission request, wherein the data transmission comprises the data transmission request. In some such embodiments, the system may trigger a data transmission, from the near field device to a server or external system associated of an entity associated with the data transmission request (e.g., an entity associated with the user's resource account of the user device). For instance, the data transmission of the data transmission request may occur from the near field device to a server or system associated with a banking entity, whereby the banking entity may be the same banking entity of the resource account identified in the data transmission request as the sender resource account.

In some embodiments, the triggering of the data transmission from the near field device may occur in real time or near real time the enhanced image being debriefed and the data in the data transmission request being revealed. In some embodiments, this trigger may be part of the computer-readable code within the data transmission request, which upon the debriefing the image, the near field device may determine and automatically transmit the data transmission request to the correct entity or server.

In some embodiments, and as shown in block 312, the process flow 300 may include the step of receiving, at the near field device, a data transmission confirmation, wherein the data transmission confirmation comprises an approval of the data transmission request. For example, and in some such embodiments, the near field device may receive the data transmission confirmation, and the data transmission confirmation may comprise information indicating that the data transmission request was completed. In some embodiments, the data transmission confirmation may comprise computer-readable program code that is configured to show the current data of the user account, user's resource account, and/or the like, that was impacted by on the data transmission request and data indicating when the data transmission request was completed, to which account was the data transmission request completed to (e.g., recipient account), and/or the like.

Additionally, and/or alternatively to the steps described herein with respect to block 304-312, in the process flow 300 may include blocks 314-316. In some embodiments, some or all of the steps shown in blocks 304-312 may occur before the steps of blocks 314-316, or the steps of blocks 314-316 may occur directly after the step of block 302.

In some embodiments, and as shown in block 314, the process flow 300 may include the step of receiving, from the near field device, a data transmission confirmation based on the at least one data transmission request. For instance, and in some embodiments, the system may receive the data transmission confirmation from the near field device, whereby the data transmission confirmation may comprise the same information as that listed above with respect to block 312.

In some embodiments, and as shown in block 316, the process flow 300 may include the step of storing the data transmission confirmation in the cache of the user device. For instance, the system may store the data transmission confirmation in the user device, such as but not limited to the cache storage of the user device. In some embodiments, the data transmission confirmation may be stored in the user device's long-term storage (e.g., database, hard drive, cloud storage, and/or the like).

In some embodiments, and upon receiving the data transmission confirmation, the system may configure the user device graphical user interface to show the information within the data transmission confirmation at the graphical user interface. In this manner, the user of the user device may view the confirmation that the data transmission request was completed, the information in their current account (e.g., user account, resource account, and/or the like), and/or the like.

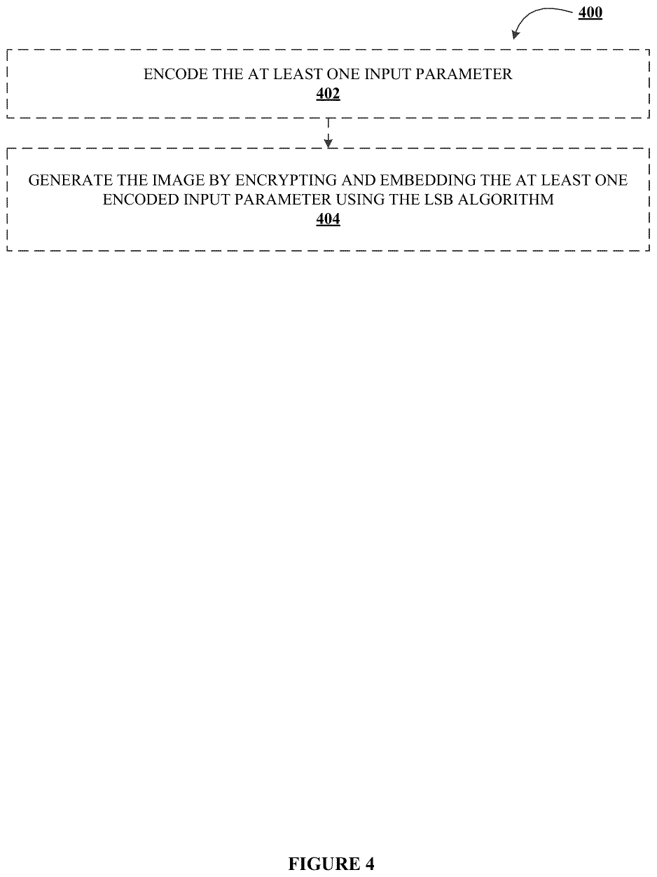

FIG. 4 illustrates a process flow 400 for generating the image, in accordance with an embodiment of the disclosure. In some embodiments, a system (e.g., similar to one or more of the systems described herein with respect to FIGS. 1A-1C) may perform one or more of the steps of process flow 400. For example, a system (e.g., the system 130 described herein with respect to FIG. 1A-1C) may perform the steps of process 400.

In some embodiments, and as shown in block 402, the process flow 400 may include the step of encoding the at least one input parameter. In some such embodiments, the system may encode the at least one input parameter into the image. For instance, the system may convert the input parameter(s) to a hexadecimal bit, and then using these hexadecimal bits, the system may apply the sub-byte technique to encode the data by substituting bytes and then swapping the bytes randomly.

In some embodiments, and as shown in block 404, the process flow 400 may include the step of generating the image by encrypting and embedding the at least one encoded input parameter using the LSB algorithm. Additionally, and as mentioned above, the system may apply an LSB algorithm to the encoded data to create an image. Thus, the image created may have hidden information within its pixel data based on updating the bits for the pixel data with portions of the byte(s) (e.g., one or more bits) from the encoded data.

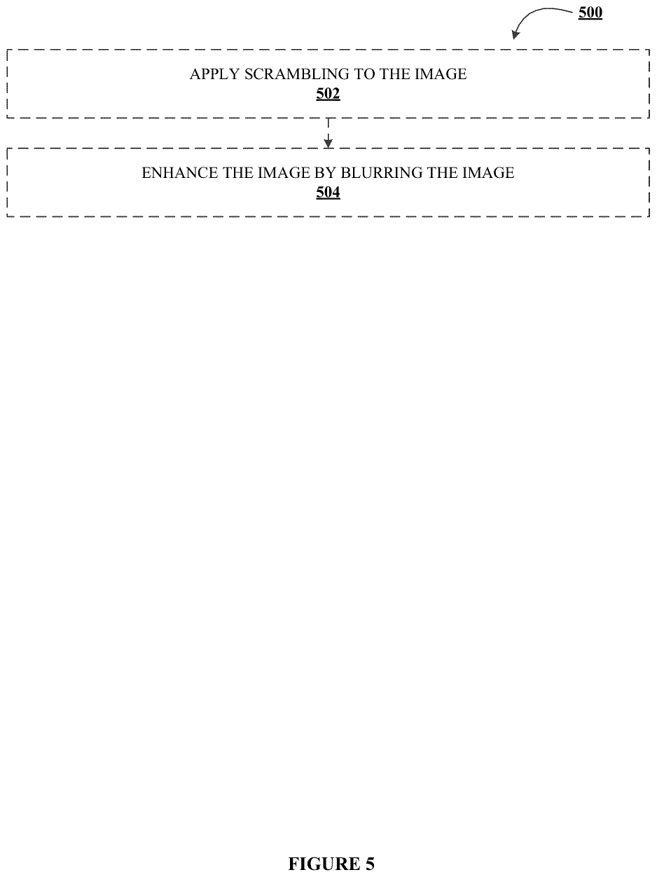

FIG. 5 illustrates a process flow 500 for enhancing the image, in accordance with an embodiment of the disclosure. In some embodiments, a system (e.g., similar to one or more of the systems described herein with respect to FIGS. 1A-1C) may perform one or more of the steps of process flow 500. For example, a system (e.g., the system 130 described herein with respect to FIG. 1A-1C) may perform the steps of process 500.

In some embodiments, and as shown in block 502, the process flow 500 may include the step of applying a scrambling to the image. For instance, the system may apply a scrambling factor to the image after the image has been created with the encoded data. Such a scrambling factor may be predetermined by a user of the user device, by the system itself, by a near field device, and/or the like. As used herein, the scrambling factor may be applied to the image using the scrambling factor as a numerical value that determines the degree at which the image and its pixels are rearranged. In some embodiments, the scrambling factor may be used as the number of times the pixels are scrambled (e.g., a numerical value of 2 may indicate the pixels will be scrambled two times).

In some embodiments, and as shown in block 504, the process flow 500 may include the step of enhancing the image by blurring the image. For instance, the system may enhance the image by blurring the image using a blurring factor. Similar to the scrambling factor, the blurring factor may be predetermined by a user of the user device, by the system itself, by the near field device, and/or the like. As used herein, the blurring factor may be applied to the image based on the blurring factor comprising a numerical value that is used as the degree that the image is made less clear. In some embodiments, the blurring factor may be used in different image processing techniques, and such image processing techniques may comprise, but are not limited to, a Gaussian blur, box blur, Fourier blur, and/or the like. In some preferred embodiments, the blurring factor may be part of a linear image processing, whereby the blurring factor may be added to the image after the scrambling factor as been applied (e.g., where A represents the scrambling factor, X represents the image, and B represents the blurring factor, the formula for encoding the image may comprise AX+B).

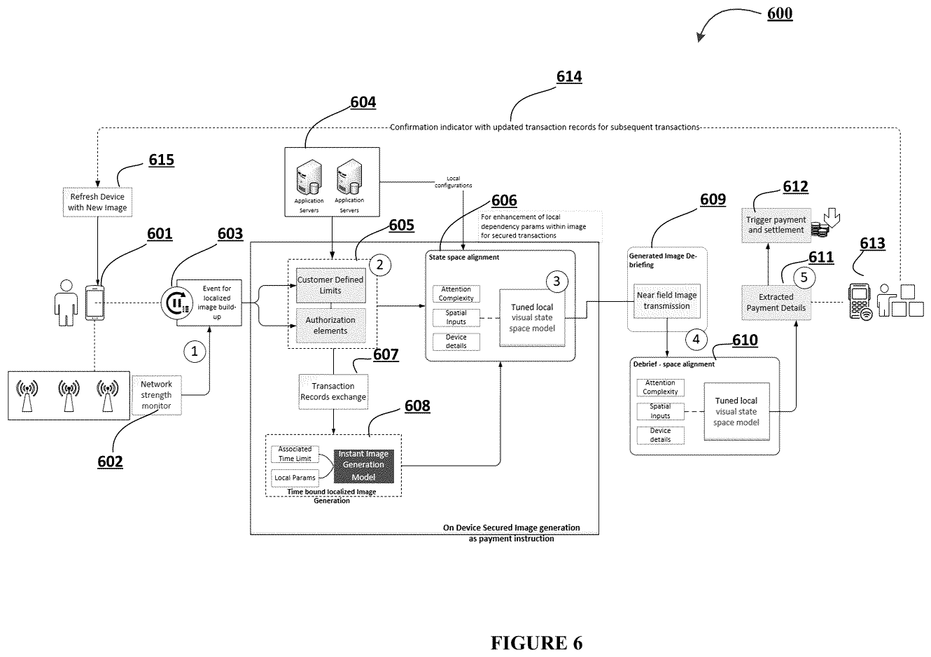

FIG. 6 illustrates an architecture flow 600 for data transmissions using near field communication and secure image generation in offline environments, in accordance with an embodiment of the disclosure. In some embodiments, a system (e.g., similar to one or more of the systems described herein with respect to FIGS. 1A-1C) may perform one or more of the steps of process flow 600. For example, a system (e.g., the system 130 described herein with respect to FIG. 1A-1C) may perform the steps of process 600.

For example, and as shown in architecture flow 600, the process may start with a user at their user device 601, where the user device may operably coupled with, or comprise a network strength monitor 602. Such a network strength monitor 602 may be configured to determine if the network continues to be steady and available, or if the network becomes inconsistent (i.e., fluctuates) and/or is no longer available. In an instance where the network is fluctuating or no longer available, the system may trigger an event for localized image generation or build-up 603. Such an event for localized image generation may occur using certain user or user device data 605, such as but not limited to customer (e.g., user of the user device) defined limits (e.g., transmission limit per day such as $100 a day limit, and/or the like), authorization limits (e.g., an authorization parameter localized to the user device), and/or the like. Further, and once the system has gathered this user or user device data 605, the system may access a transaction records exchange 607, whereby the transaction records exchange comprises historical transactions using this no or low network image generation and data transmission system and/or normal methods of data transmissions over working networks. In this manner, the transaction records exchange may keep a full record of the data transmissions that have been requested and completed and may use this data in generating new images and transmitting these images for secure data transmissions. In some embodiments, the transaction records exchange may be used by the system to track previous transactions, and how the previous transactions have updated the balance in a user's resource account, and/or a pre-set amount for the current transaction in the data transmission request.

As shown in time bound localized image generation 608, the system may use the device data and user data 605, and/or the transaction records exchange, along with an associated time limit for the image/data transmission request and localized parameters to generate the image that will be encoded with the data transmission request data. Such an instant image generation model within the time bound localized image generation 608 may comprise an LSB algorithm to generate the image that will be applied to the state space model 606. For example, the state space model 606 may be configured to enhance the image generated in block 608 by scrambling and blurring on the image. In some embodiments, the state space model may comprise attention complexity, spatial inputs, and device details (e.g., local parameters) to generate the tuned local visual state space model, which may then be used to enhance the image. In some embodiments, application servers 604 associated with the user device to determine the user/customer defined limits and the authorization limits 605 as well as to tune the state space model 606.

Further, and in some embodiments, the system may transmit the enhanced image to a near field device via near field image transmission 609, which may be configured to debrief the enhanced image. For example, the debrief of the enhanced image may occur at the debrief space alignment 610, and the debrief-space alignment may comprise the same steps listed above in generated the enhanced image, but in the reverse. For instance, the debrief space alignment may also comprise attention complexity, spatial inputs, and device details to generate the tuned visual state space model which is configured to debrief the specific image generated by the system.

Upon debriefing the enhanced image, the near field device may extract the data transmission request information (e.g., the payment details in an instance where the data transmission request is a resource transmission request). Thus, the near field device may determine a recipient server and/or entity and transmit the data transmission request to the correct server or entity, which may trigger the payment and settlement for a resource transmission request 612. Further, and in order to bring the user device up to date on the current status of the user's user account, the near field device 613 may transmit a confirmation indicator (e.g., data transmission confirmation) with updated transaction records for subsequent transactions 614. In some embodiments, the data transmission confirmation transmitted may be in the form of a new image 615 generated using the same methods as those described herein.

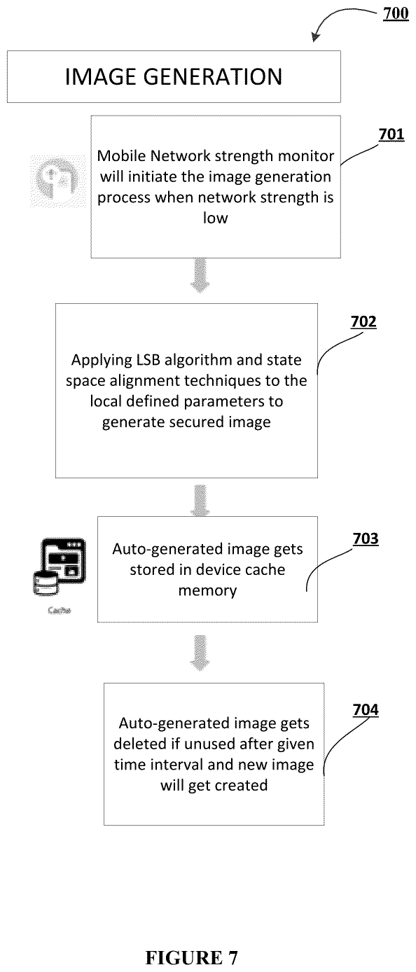

FIG. 7 illustrates an exemplary flow 700 for image generation, in accordance with an embodiment of the disclosure. In some embodiments, a system (e.g., similar to one or more of the systems described herein with respect to FIGS. 1A-1C) may perform one or more of the steps of process flow 700. For example, a system (e.g., the system 130 described herein with respect to FIG. 1A-1C) may perform the steps of process 700.

For example, and as shown in exemplary flow 700, the process for generating the image may comprise—at block 701—a mobile network strength monitor (e.g., to test fluctuations in the network), where the mobile network strength monitor may initiate the image generation process when the network strength is determined to be low.

As shown in block 702, the process for generating the image may continue by applying an LSB algorithm and state space model (i.e., state space alignment techniques) to the local defined parameters to generate the secured image. Thus, and in other words, the image may be generated using the LSB algorithm to update the bits within the pixels in the image, and then a scrambling factor and a blurring factor may be applied using the state space model.

As shown in block 703, the auto-generated image may get stored in the user device's cache memory. Thus, the auto-generated image may be stored for short time periods and cannot be used past their time limit, while also promoting for quick recall of the image for transmission to a near field device.

As shown in block 704, the auto-generated image may get deleted if unused after a given time interval (e.g., a time limit on the image) and a new image will be created in its place. Thus, and in this manner, the system will ensure the images cannot be used after their time limit, and thus, the images will remain secure and ever-changing to prevent potential copying or man-in-the-middle attacks and brute force cyber attacks at a later time with the image, as the images will not longer be useable.

FIG. 8 illustrates an exemplary flow 800 for encoding and decoding the image, in accordance with an embodiment of the disclosure. In some embodiments, a system (e.g., similar to one or more of the systems described herein with respect to FIGS. 1A-1C) may perform one or more of the steps of process flow 800. For example, a system (e.g., the system 130 described herein with respect to FIG. 1A-1C) may perform the steps of process 800.

As shown in block 801, the system may convert the input parameters to hexadecimal bits, such that the input parameters can be encoded to the image generated in FIG. 7. As shown in block 802, the system may then apply a sub-byte technique to encode the data of the bits by substituting the bits within the bytes from the pixels of the image to the bits of the input parameters. In this manner, the bits from the input parameters may be hidden within the bytes of the pixels of the image. As shown in block 803, the system may then apply the LSB algorithm to create the image with the encoded data. Further, and as shown in block 804, the system may then scramble the image based on the pixel positions using image processing methods (e.g., scrambling factor, and/or the like).

Further, and as shown in block 805, the system may input the image from block 804 to a tuned local visual state space model which is configured with local parameters of attention complexity, device details, and spatial inputs. In some embodiments, the scrambling that occurred in block 804 may be carried out by the state space model. The image modified by the state space model may comprise the enhanced or tuned image that is transmitted using near field image transmission techniques to a near field device at block 806.

As shown in block 807, the tuned or enhanced image may be debriefed with another instance of the state space model at the near field device (e.g., a point of sale (POS) device) using the same techniques applied during encryption. As shown in block 808, the output image from block 807 may be applied with image processing techniques by arranging pixels based on pixel position to get the de-scrambled image. As discussed briefly above, the de-scrambling of the image may occur in the state space model at the near field device.

As shown in block 809, an inverted LSB algorithm may be applied to the image from block 808, and the encoded data from the image may be identified. As shown in block 810, and upon identifying the encoded data, sub-byte methods or techniques may be applied to the encoded data to determine the hexadecimal data. Based on the hexadecimal data, and as shown in block 811, the hexadecimal bits from the hexadecimal data may be converted to digits to retrieve the customer data/data transmission request.

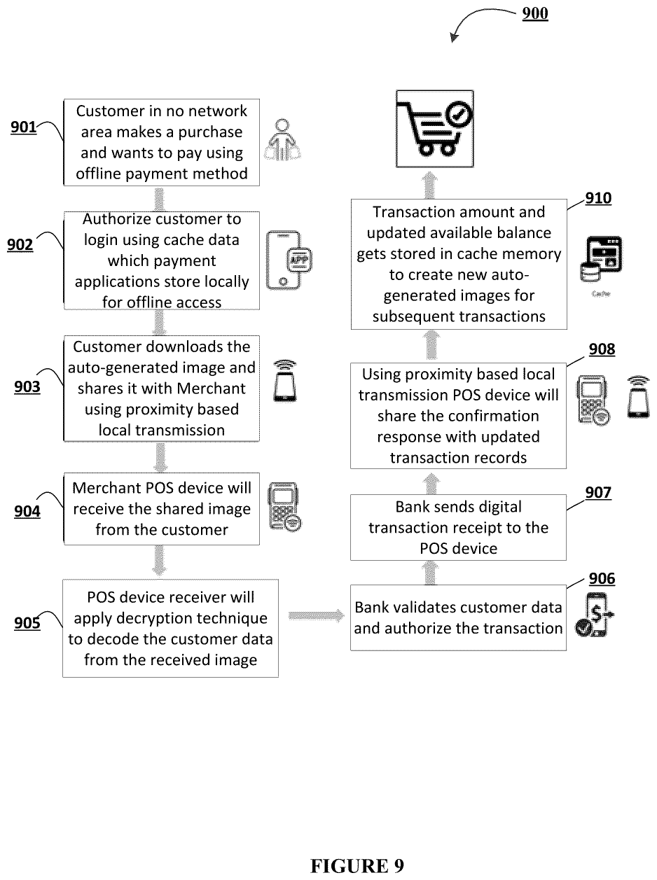

FIG. 9 illustrates an exemplary flow 900 for completing a data transmission request for a user in a low or no network environment, in accordance with an embodiment of the disclosure. In some embodiments, a system (e.g., similar to one or more of the systems described herein with respect to FIGS. 1A-1C) may perform one or more of the steps of process flow 900. For example, a system (e.g., the system 130 described herein with respect to FIG. 1A-1C) may perform the steps of process 900.

As shown in FIG. 9, an exemplary use case comprising a resource transmission request is shown and described. For instance, and as shown in block 901, the system may determine that the user device and/or the user are in a no (or low) network area and the user is unable to make a purchase and wants to pay using an offline payment method, like the payment method described herein as an embodiment. Further, and as shown in block 902, the user device associated with the user may authorize the customer/user to login using cache data that allows the user to login into payment applications by using locally stored data (such as authentication credentials, and/or the like) to access the applications during offline access. As shown in block 903, the system may determine the customer/user has downloaded the auto-generated image (e.g., the image generated and modified in FIGS. 7 and 8) and the user allows the user device to share the auto-generated image with a merchant's device. Such a sharing of the auto-generated image may comprise proximity based local transmission, or near field communication. In some embodiments this merchant device may be a point of sale (POS) device.

Further, and as shown in block 904, the merchant's near field device may receive the shared image from the user's user device. As shown in 905, the near field device may apply decryption techniques to decode the customer data from the received image (e.g., such as the decryption techniques described herein with respect to state space models, unblurring, unscrambling, hexadecimal bits, and/or the like).

As shown in block 906, the third party entity associated with the data transmission (e.g., a bank) may validate the customer/user data and authorize the transaction to be completed. At block 907, the third party entity may send a digital transaction receipt (e.g., data transmission confirmation) back to the near field device. Additionally, and as shown in block 908, the near field device may use proximity based local transmission techniques (e.g., near field communication) to share the confirmation response with the updated transaction records to the user device. As shown in block 910, the transaction amount and updated available balance may get stored in the cache memory, and this stored data and images may be used later to create new auto-generated images for subsequent transactions.

As will be appreciated by one of ordinary skill in the art, the present disclosure may be embodied as an apparatus (including, for example, a system, a machine, a device, a computer program product, and/or the like), as a method (including, for example, a business process, a computer-implemented process, and/or the like), as a computer program product (including firmware, resident software, micro-code, and the like), or as any combination of the foregoing. Many modifications and other embodiments of the present disclosure set forth herein will come to mind to one skilled in the art to which these embodiments pertain having the benefit of the teachings presented in the foregoing descriptions and the associated drawings. Although the figures only show certain components of the methods and systems described herein, it is understood that various other components may also be part of the disclosures herein. In addition, the method described above may include fewer steps in some cases, while in other cases may include additional steps. Modifications to the steps of the method described above, in some cases, may be performed in any order and in any combination.

Therefore, it is to be understood that the present disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for data transmissions using near field communication and secure image generation in offline environments, the system comprising:
a processing device;
a non-transitory storage device containing instructions when executed by the processing device, causes the processing device to perform the steps of:
determine a network fluctuation for a user device;
identify at least one data transmission request from the user device;
generate, based on determining the network fluctuation, an image based on the at least one data transmission request and at least one input parameter from the user device, wherein the image is generated with a least significant bit (LSB) algorithm;
enhance, using a state space model, the image; and
trigger a download of the enhanced image to a cache of the user device.

2. The system of claim 1, wherein executing the instructions further causes the processing device to:
trigger a transmission of the enhanced image from the cache to a near field device.

3. The system of claim 2, wherein executing the instructions further causes the processing device to:
trigger, at the near field device, a decode of the enhanced image, wherein the decoding comprises:
applying a state space model associated with the near field device to the enhanced image; and
extract, using the state space model associated with the near field device, the at least one data transmission request and the at least one input parameter.

4. The system of claim 3, wherein executing the instructions further causes the processing device to:
trigger, at the near field device, a data transmission to a server associated with the data transmission request, wherein the data transmission comprises the data transmission request; and
receive, at the near field device, a data transmission confirmation, wherein the data transmission confirmation comprises an approval of the data transmission request.

5. The system of claim 2, wherein executing the instructions further causes the processing device to:
receive, from the near field device, a data transmission confirmation based on the at least one data transmission request in the enhanced image; and
store the data transmission confirmation in the cache of the user device.

6. The system of claim 1, wherein the network fluctuation is based on a continuous monitoring of a network associated with the user device.

7. The system of claim 1, wherein the at least one input parameter comprises at least one user account parameter, at least one user device parameter, at least one localized parameter, or at least one time limit parameter.

8. The system of claim 7, wherein the generation of the image comprises:
encoding the at least one input parameter; and
generating the image by encrypting and embedding the at least one encoded input parameter using the LSB algorithm.

9. The system of claim 1, wherein the state space model comprises:
applying scrambling the image; and
enhancing the image by blurring the image.

10. A computer program product for data transmissions using near field communication and secure image generation in offline environments, wherein the computer program product comprises at least one non-transitory computer-readable medium having computer-readable program code portions embodied therein, the computer-readable program code portions which when executed by a processing device are configured to cause the processor to:
determine a network fluctuation for a user device;
identify at least one data transmission request from the user device;
generate, based on determining the network fluctuation, an image based on the at least one data transmission request and at least one input parameter from the user device, wherein the image is generated with a least significant bit (LSB) algorithm;
enhance, using a state space model, the image; and
trigger a download of the enhanced image to a cache of the user device.

11. The computer program product of claim 10, wherein the computer-readable program code portions which when executed by the processing device are configured to cause the processor to:
trigger a transmission of the enhanced image from the cache to a near field device.

12. The computer program product of claim 11, wherein the computer-readable program code portions which when executed by the processing device are configured to cause the processor to:
trigger, at the near field device, a decode of the enhanced image, wherein the decoding comprises:
applying a state space model associated with the near field device to the enhanced image; and
extract, using the state space model associated with the near field device, the at least one data transmission request and the at least one input parameter.

13. The computer program product of claim 12, wherein the computer-readable program code portions which when executed by the processing device are configured to cause the processor to:
trigger, at the near field device, a data transmission to a server associated with the data transmission request, wherein the data transmission comprises the data transmission request; and
receive, at the near field device, a data transmission confirmation, wherein the data transmission confirmation comprises an approval of the data transmission request.

14. The computer program product of claim 11, wherein the computer-readable program code portions which when executed by the processing device are configured to cause the processor to:
receive, from the near field device, a data transmission confirmation based on the at least one data transmission request in the enhanced image; and
store the data transmission confirmation in the cache of the user device.

15. The computer program product of claim 10, wherein the at least one input parameter comprises at least one user account parameter, at least one user device parameter, at least one localized parameter, or at least one time limit parameter.

16. A computer implemented method for data transmissions using near field communication and secure image generation in offline environments, the computer implemented method comprising:
determining a network fluctuation for a user device;
identifying at least one data transmission request from the user device;
generating, based on determining the network fluctuation, an image based on the at least one data transmission request and at least one input parameter from the user device, wherein the image is generated with a least significant bit (LSB) algorithm;
enhancing, using a state space model, the image; and
triggering a download of the enhanced image to a cache of the user device.

17. The computer implemented method of claim 16, further comprising:
trigger a transmission of the enhanced image from the cache to a near field device.

18. The computer implemented method of claim 17, further comprising:
trigger, at the near field device, a decode of the enhanced image, wherein the decoding comprises:
applying a state space model associated with the near field device to the enhanced image; and
extract, using the state space model associated with the near field device, the at least one data transmission request and the at least one input parameter.

19. The computer implemented method of claim 18, further comprising:
triggering, at the near field device, a data transmission to a server associated with the data transmission request, wherein the data transmission comprises the data transmission request; and
receiving, at the near field device, a data transmission confirmation, wherein the data transmission confirmation comprises an approval of the data transmission request.

20. The computer implemented method of claim 17, further comprising:
receiving, from the near field device, a data transmission confirmation based on the at least one data transmission request in the enhanced image; and
storing the data transmission confirmation in the cache of the user device.
